(19) United States
(12) Patent Application Publication
(10) Pub. No.: US 2015/0239721 A1
(43) Pub. Date: Aug. 27, 2015

(54) POWER OPERABLE CAN OPENER

(71) Applicant: JOSEPH A. BECHTOLD, PARMA, OH (US)

(72) Inventor: JOSEPH A. BECHTOLD, PARMA, OH (US)

(21) Appl. No.: 14/544,793

(22) Filed: Feb. 18, 2015

Related U.S. Application Data
(60) Provisional application No. 61/966,284, filed on Feb. 21, 2014.

(51) Int. Cl. B67B 7/46

(52) U.S. Cl. CPC B67B 7/34

(57) ABSTRACT

A rugged, heavy duty, industrial-type hand held can opener tool is provided with a male drive formation to which a battery operated power drill or the like may be connected so the tool may be held in one hand, and may be operated by a power tool held in the other hand. When two pivotally connected handles of the can opener close toward each other, a cutting formation carried on one handle and a toothed drive wheel carried on the other handle grip the can. As the handles close, the cutting formation punctures the lid of the can adjacent the rim of the can. As the drive wheel rotates causing the can to turn, the cutting formation smoothly circumferentially severs the lid from the rim. The severed lid and the burr-free de-lidded can fall free when the handles are opened.

### REFERENCE TO PROVISIONAL APPLICATION

This application claims the benefit of the filing date of provisional application Ser. No. 61/966,284 filed Feb. 21, 2014 entitled HEAVY DUTY HAND HELD CAN OPENER WITH POWER DRIVE CONNECTOR FOR REMOVING RIMS FROM PAINT CANS AND THE LIKE (Atty's Dkt. 6-600), the disclosure of which is incorporated by reference.

### FIELD OF THE INVENTION

The present invention relates to an improved, hand held can opener tool that is provided with a drive connector to which a battery operated power drill or the like can be drivingly connected so the can opener tool can be gripped in one hand and driven with a power tool held in the other hand to cleanly sever, with relative ease, the lids of typically heavily constructed gallon paint cans and the like from the upstanding sidewalls of the cans when the can opener tool is brought into gripping engagement with, and is then effectively caused to travel smoothly around the circumference of the rim of each of a sequence of gallon paint cans or the like.

### BACKGROUND

Hand held, hand operated can openers are well known that have knobs or other forms of graspable handles that can be manually twisted or manually turned to apply torque as may be needed to sever lids from the relatively lightweight kitchen cans that commonly contain such edible commodities as fruits and vegetables. The conventional kitchen can opener is designed to grip, one at a time, the top portions of a sequence of relatively thin-walled cans, and to create circular lines of cut as lids are severed from the upstanding side walls of the kitchen cans.

One inexpensive, manually operable, hand held can opener that has gained wide acceptance and has sold in sizable quantities year after year is offered by Swing-A-Way Products LLC of Vernon Hills, Ill. under the registered trademark SWING-A-WAY. Although the relatively light-weight, hand held SWING-AWAY can opener is well suited to open such relatively lightweight can-type containers as are commonly used to package fruits, vegetables and other edible commodities, such lightweight can opener tools as the SWING-A-WAY can opener can be quite difficult if not impossible to use as a tool for sequentially removing a series of inwardly-extending rims from such heavily constructed tops as are found on gallon cans, in which paint and other coating materials are sold.

If an attempt is made to use the SWING-A-WAY can opener to remove the heavily constructed, inwardly extending rims from gallon paint cans, a great deal of torque must be applied to the can opener—often manual force of such a magnitude as can cause pain or do injury to the hands of elderly persons or others who do not have strong hands that are well suited to the task. Use of such a conventional kitchen can opener in an attempt to sever the inwardly extending rim portions of a sequence of gallon paint cans tends to cause rapid deterioration of the tool.

Recognizing that manually applying strong torque to a can opener can significantly strain one's hands, some manufacturers of hand held can openers have provided can openers with ratcheting mechanisms that enable torque to be applied a little at a time in a series of start-and-stop forward turning motions as one grips, twists, and then backwardly turns a knob or handle of the can opener before resuming the forward turning of the knob or handle. A problem with applying torque in a series of bursts is that the resulting line of cut along which the top of a can is severed from the upstanding side wall is often quite jagged and populated by nasty by splinter-like burrs that appear at closely spaced intervals. A far more desirable line of cut that is less likely to carry unwanted burrs results if a can opener can be kept in continuous motion as a circular line of severance is created where a can lid is disconnected from an upstanding side wall of a

### SUMMARY OF THE INVENTION

The present invention addresses the foregoing and other drawbacks of the prior art by providing a hand held can opener with a toothed drive wheel carried on a drive shaft having a male drive formation to which a battery powered portable drill or the like can be quickly and easily connected—so a sequence of gallon paint cans or the like cans can be smoothly and easily de-lidded as the can opener is driven by the power tool held in one hand to cause the can opener held in the other hand to effectively move the toothed drive wheel around the underside of the rims of the cans while a cutting formation of the can opener smoothly severs the lids of the cans from the upstanding sidewalls of the cans.

The rim region of each can is gripped between the toothed drive wheel and the cutting formation as the two elongate, pivotally connected handles of the tool are closed toward each other—which causes the cutting formation to begin lid severance by piercing a perimeter region of the can's lid, at the same time that the toothed drive wheel is being clamped firmly into engagement with an underside of the can's rim. As the power tool turns the toothed drive wheel, relative movement takes place between the securely gripped can and the can opener—which draws the cutting formation smoothly around the circumference of the gripped can's rim, severing the lid from the rim. When the handles are pivoted apart or opened, the severed lid and the burr-free de-lidded can fall free.

In all embodiments of the invention, a male drive formation is provided on a drive shaft that is securely drivingly connected to a toothed drive wheel. In all embodiments, the drive shaft is rotatable relative to the handle on which it is carried. Being able to drivingly couple a power tool to the toothed drive wheel that turns a gallon paint can or the like relative to the can opener is an important feature of the invention.

In all embodiments of the invention, the cutting formation is carried on the handle that does not carry the rotatable toothed drive wheel. This arrangement is of importance to the invention because, as the pivotally connected handles of the can opener are gripped and squeezed toward each other (i.e., as the handles are “closed” together) the cutting formation needs to puncture a peripheral portion of the lid of the can that is being gripped by the opener; and, as the can is turned, the squeezed-together handles need to maintain the position of the cutting formation, so it will circumferentially sever the can's lid smoothly and cleanly, leaving a burr-free de-lidded can.

In some embodiments, the cutting formation takes the form of a cutter wheel that is rotatably carried by the handle on which the rotatable cutter wheel is carried. The cutter wheel turns about an axis that is slightly inclined relative to a pair of parallel-extending axes about which the handles pivot relative to each other, and about which the toothed drive wheel rotates relative to the handle on which it is carried. Gears carried on the shafts on which the cutter wheel and the toothed drive wheel are mounted are caused to drivingly engage when the handles are pivoted toward each other cause the cutter wheel to turn as the toothed drive wheel turns.

However, in a much preferred embodiment, the cutting formation takes the form of a hardened metal edge formation carried on the handle that does not carry the toothed drive wheel. There are no gears that need to drivingly engage as the handles close toward each other, and there is no cutter wheel that needs to turn as the toothed drive wheel turns. This much simpler arrangement does not consume torque that is applied to the drive shaft—all of which torque is transmitted directly to the toothed drive wheel and is used to turn, relative to the can opener, a can that is being de-lidded.

In a preferred embodiment, both of the distal end regions of the handles (i.e., the end regions that are not pivotally connected) are provided with ergonomically configured hand grips that aid the user in gripping and efficiently and comfortably applying force to the pivotally connected handles.

In a preferred embodiment, a spring is interposed between the two handles to bias the handles away from each other—to assist the handles move apart or “opening” once the handles are no longer being squeezed together, which signals the completion of a de-lidding task.

### DESCRIPTION OF THE DRAWINGS

Such features as are described above, and a fuller understanding of the invention may be had by referring to the description and claims that follow, taken in conjunction with the accompanying drawings, wherein:

FIG. 1 is a left side elevational view of a hand held manually operated kitchen can opener of a PRIOR ART type sold under the registered trademark SWING-A-WAY by Swing-A-Way LLC of Vernon Hills, Ill. 60061, with the view showing the pivotally connected elongate arms or handles of the can opener in a spread apart or open state;

FIG. 2 is a front end elevational view of the PRIOR ART hand held kitchen can opener of FIG. 1, with the elongate arms or handles of the opener pivoted toward each other and shown in a closed state;

FIG. 3 is a schematic depiction showing how the PRIOR ART kitchen can opener of FIGS. 1 and 2 typically cuts through a perimeter part of a lid of a conventional relatively lightweight kitchen can such as is commonly used to contain fruits, vegetables and other edible foodstuffs, with the view showing an inclined axis A about which a cutting formation (namely a cutting wheel) of the can opener rotates as the cutting formation severs a lid from the depicted kitchen can shown in cross-section;

FIG. 4 is a schematic depiction similar to FIG. 3 but showing how a an industrial type of can opener utilizing a larger cutting formation (namely a larger diameter cutting wheel) is used to cut through an inwardly extending rim part of a relatively thick gallon paint can, with this view also showing an inclined axis A about which the depicted cutting wheel rotates;

FIG. 5 is a left side elevational view similar to FIG. 1 but showing the left side of the industrial—type can opener of FIG. 4, with the view showing the pivotally connected handles or arms of the can opener in a spread apart or open state wherein the cutting formation (i.e. the cutting wheel) is moved away from the toothed drive wheel that causes relative movement of a gripped can and the can opener;

FIG. 6 is a perspective view showing a portion of the right side of the heavy duty can opener of FIGS. 4 and 5 with the pivotally connected elongate handles or arms in a moved-together or closed state, with the view showing how the shaft that carries a toothed engagement wheel on the left side of the opener is extended on the right side of the opener to provide a drive formation that can easily be grasped and turned by the chuck of a battery operated power drill or the like;

FIG. 7 is a left side view of an industrial type of can opener similar to FIG. 7 that has its pivotally connected handles or arms provided with ergonomically configured hand grips, with a torsion spring being interposed between the pivotally connected handles or arms to assist in opening or moving the handles or arms apart, and with the depicted can opener having a cutting or piercing formation that again takes the form of a rotatable cutting wheel;

FIG. 8 is a left side view similar to FIG. 7 but showing an industrial type of can opener that has its pivotally connected handles or arms provided with ergonomically configured hand grips and a spring that are similar to these same features as shown in FIG. 7, but with the depicted can opener having a cutting or piercing formation that takes the form of a hardened cutting edge or surface instead of a rotatable wheel; and,

FIG. 9 is a foreshortened end view of an upper portion of one of the handles or arms of the can opener shown i FIG. 7, showing the toothed drive wheel and a rotatable shaft that is drivingly connected to the toothed drive wheel.

### DETAILED DESCRIPTION

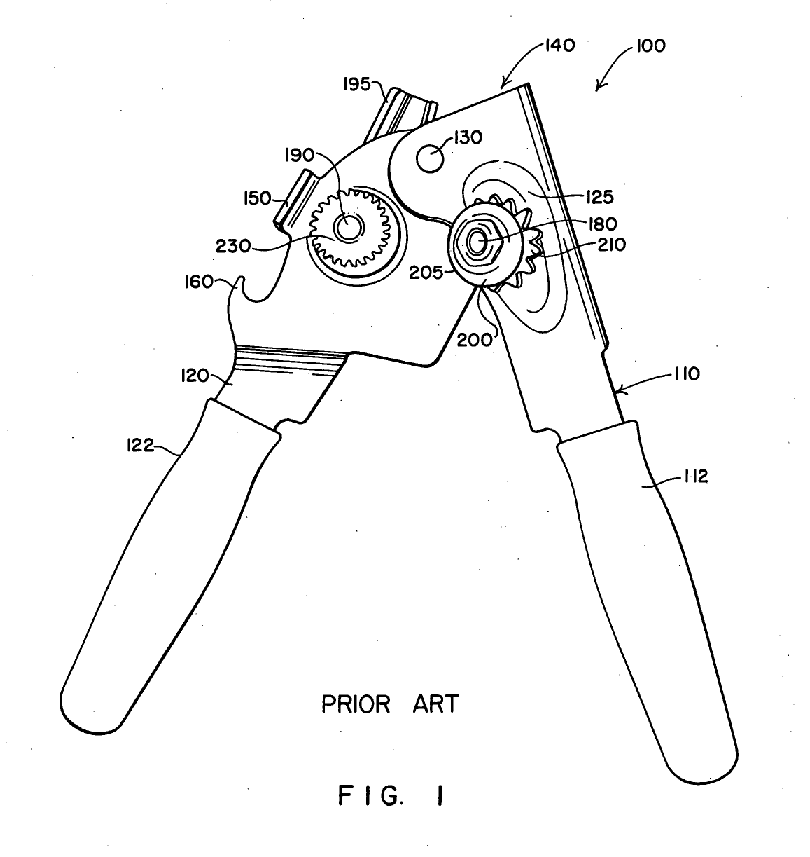

Referring to FIG. 1, a hand held can opener of a type sold by SWING-A-WAY LLC of Vernon Hills, Ill. is indicated generally by the numeral 100. The can opener 100 includes an upper arm 110 and a lower arm 120 that are pivotally connected by a pivot shaft 130 that extends through aligned holes (not shown) near a front end region 140 of the arms 110, 120. Relatively plain plastic hand grips 112, 122 cover distal end regions of the arms 110, 120.

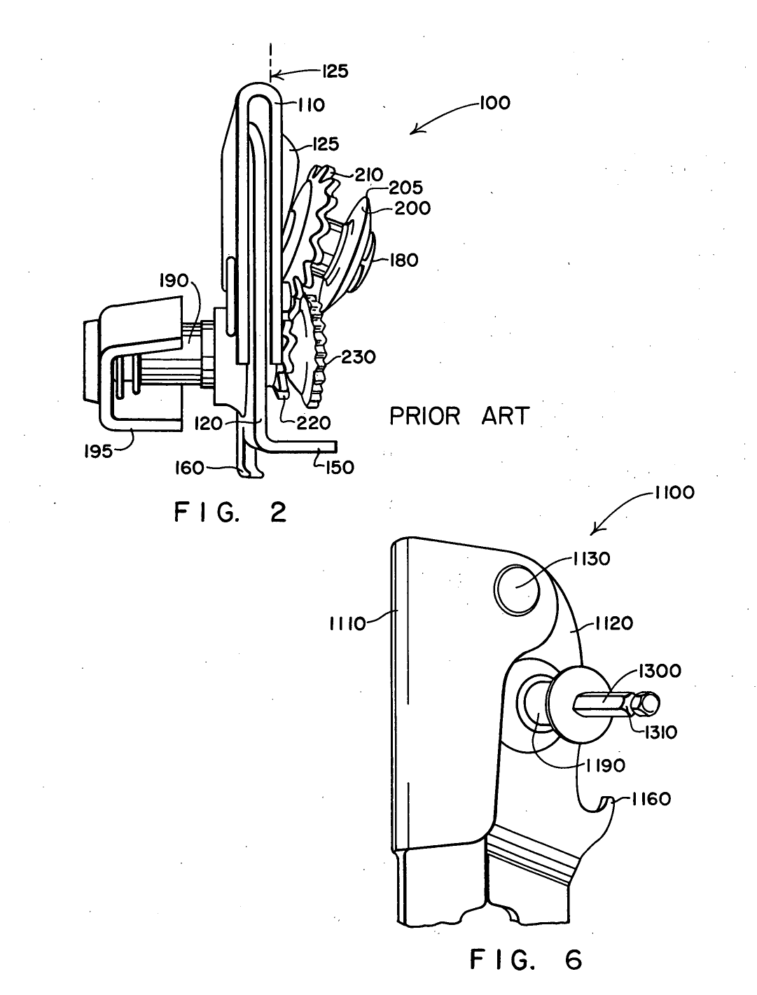

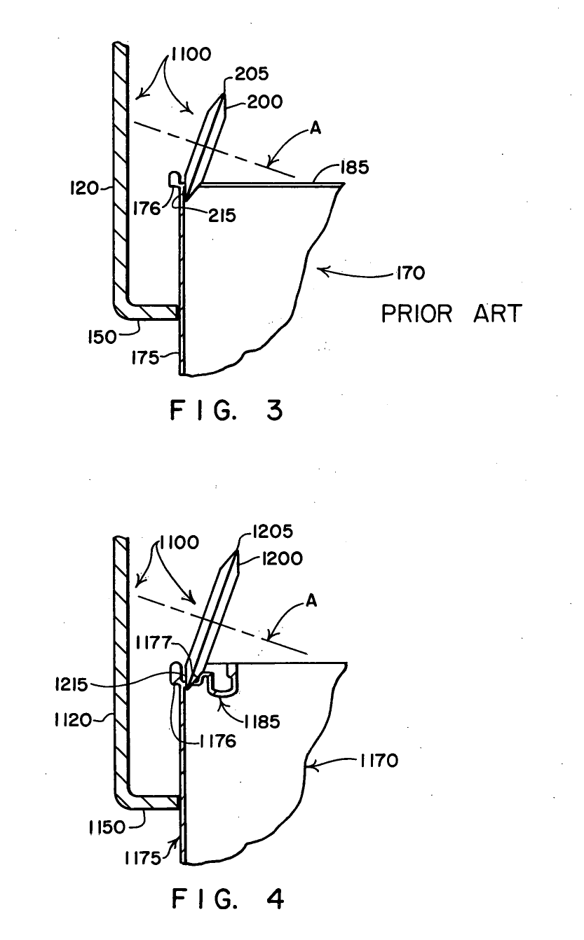

Referring to FIG. 2, a small, transversely extending bottom part 150 of the lower arm 120 is provided to engage an upstanding sidewall 175 of a conventional kitchen can 170 as shown in FIG. 3 to assist in properly positioning the can opener 100 (in the manner depicted in FIG. 3) for use in severing a lid 185 from the conventional kitchen can 170.

Referring to FIGS. 1 and 2, a left side portion of the upper arm 110 defines a leftwardly extending bulged region 125 from which a an upper drive shaft 180 extends leftwardly at an inclined angle represented by an axis A in FIG. 3. The upper drive shaft 180 is located above the transversely extending projection 150 of the lower arm 120, and is inclined slightly downwardly as can best be seen in FIG. 2, and as is represented by the axis A in FIG. 3. A cutting or piercing formation that takes the form of a hardened circular cutter wheel 200, together with a gear 210 (FIGS. 1 and 2) are rotatable with the upper drive shaft 180 when the upper drive shaft 180 turns about the axis A. The cutter wheel 200 and the gear 210 are interconnected for concurrent rotation by the upper drive shaft 180, which turns about the axis A of the upper drive shaft 180.

A lower drive shaft 190 extends (leftwardly as viewed in FIG. 1, but rightwardly as viewed in FIG. 2) from the lower arm 120 at a location between the upper drive shaft 180 and the transversely extending projection 150. A gear 220 and a toothed drive wheel 230 drivingly connected for concurrent rotation about the axis of the lower drive shaft 190.

When the upper and lower arms 110, 120 are pivoted and closed toward each other to bring the gears 210, 220 into meshed driving engagement, rotation of the lower drive shaft 190 in a selected clockwise or counterclockwise direction causes counterrotation of the upper drive shaft 180 in the opposite clockwise or counter-clockwise direction. The oppositely turning drive shafts 180, 190 cause the cutter wheel 200 and the toothed drive wheel 230 to also turn concurrently, but in opposite directions of rotation.

When brought into gripping engagement with the kitchen can 180, the toothed drive wheel 230 bites into the underside or small downwardly-facing surface 176 (FIG. 3) located near where the upwardly extending sidewall 175 joins a perimeter of the lid 185, so that relative motion will occur between the can 180 and the opener 100 as a handle 195 also connected to the lower drive shaft 190 is turned to cause rotation of the toothed drive wheel 230.

When the can opener 100 is properly positioned to engage and sever the lid 185 from the kitchen can 170, the cutting wheel 200 of the can opener 100 is oriented at an inclined angle (as shown in FIG. 3) to rotate about an axis A that also is oriented at an inclined angle so a sharpened cutting edge 205 of the cutting wheel 200 has a surface 215 that extends relatively nearly parallel to the upstanding sidewall 175 of the kitchen can 170.

As is best seen in FIG. 1, the conventional kitchen can opener 100 may be provided with other features such as a hook formation 160 defined by a bottom portion of the lower handle 120. The hook formation 160 may be used to remove conventionally crimped caps (not shown) from soda pop bottles, or beer bottles, or the like.

FIGS. 4, 5 and 6 are provided to illustrate features of an improved, strengthened, heavier duty industrial can opener that is designated by the numeral 1100. Because the improved heavy duty can opener 1100 has many components and features that are very similar to and correspond to already described components and features of the conventional kitchen can opener 100 shown in FIGS. 1, 2 and 3, components and features of the industrial can opener 1100 that correspond to the already described components and features of the kitchen can opener 100 are designated by numerals having a magnitude greater by a quantity of one thousand—thereby eliminating a need to repeat the description of such corresponding components and features of the industrial can opener 1100 that correspond to the already described components and features of the conventional kitchen can opener 100.

Similarly, many of the components and features of a relatively heavier gallon paint can 1170 shown in FIG. 4 that correspond to components and features of the relatively lightweight conventional kitchen can 170 shown in FIG. 3, are designated by numerals that have magnitudes that are greater by a quantity of one thousand than the numerals used with the conventional kitchen can 180 shown in FIG. 3.

Referring to FIG. 4, a transversely extending lower handle portion 1150 of the opener 1100 is configured to engage an upstanding sidewall 1175 of the heavy duty can opener 1100 to assist in properly positioning the can opener 1100 during removal of an inwardly extending rim part 1185 from the gallon paint can 1170.

As also can be seen in FIG. 4, when the heavy duty can opener 1100 is properly positioned to engage and sever an inwardly extending rim part or portion 1185 from the upstanding side wall 1175 of the paint can 1180, a more robust and larger diameter cutting wheel 1200 (in comparison with the smaller diameter cutting wheel 200 shown in FIG. 3) is oriented at an inclined angle to turn about an axis A that is positioned at an inclined angle so a sharpened cutting edge 1205 of the cutting wheel 1200 has a surface 1215 that extends nearly parallel to the upstanding side wall 1175 of the paint can 1180.

As is shown in FIG. 6, the heavier duty opener 1100 is provided with an rightward extension 1300 of the lower drive shaft 1190 that carries the toothed drive wheel 1230 on the left side of the can opener 110. The shaft extension 1300 has a grooved end region 1310 that is well suited to be engaged and turned by a conventional chuck (not shown) of a conventional battery powered drill (not shown) or other similar power tools that are designed to engage a drive shaft extension (such as the extension 1300) and grip a groove (such as the groove 1310) near the end of the gripped drive shaft extension 1300—with the power tool (not shown) being conveniently held in one hand while the heavier duty industrial can opener 1100 is held in an opposite hand.

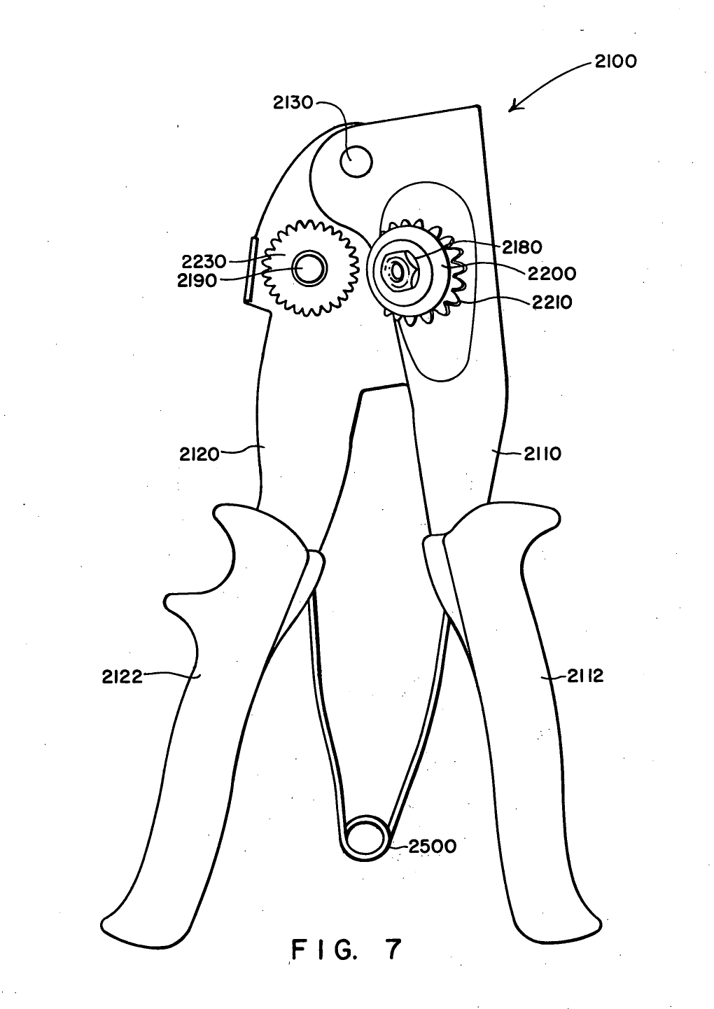

Referring to FIG. 7, a still more improved and strengthened industrial-type can opener is indicated by the numeral 2100. The can opener 2100 has a somewhat enlarged toothed drive wheel 2230 intended to provide a better grip on the underside of the rim (such as the rim surface 1176 shown in FIG. 4 that is commonly found on gallon paint cans and the like) to enable the toothed drive wheel 2230 to turn a gripped gallon paint can or the like as a cutting formation of the can opener (in this case, the depicted cutting wheel 2200) to sever the a lid circumferentially from a paint can or the like that is gripped by the can opener 2100.

The can opener 2100 depicted in FIG. 7 also has much improved, ergonomically configured hand grips or handles 2112, 2122 on distal end regions of the arms 2110, 2020, respectively, that considerably aid one in properly gripping the arms 2110, 2120 when squeezing together or closing the handles 2110, 2120. Furthermore, a torsion coil spring 2500 that is interposed between the handles 2110, 2120 biases the handles 2110, 2120 apart so that, when a de-lidding of a gripped gallon paint can or the like is completed, releasing ones squeezing grasp on the handles 2110, 2120 will permit the smoothly de-lidded can and the burr-free lid to fall free.

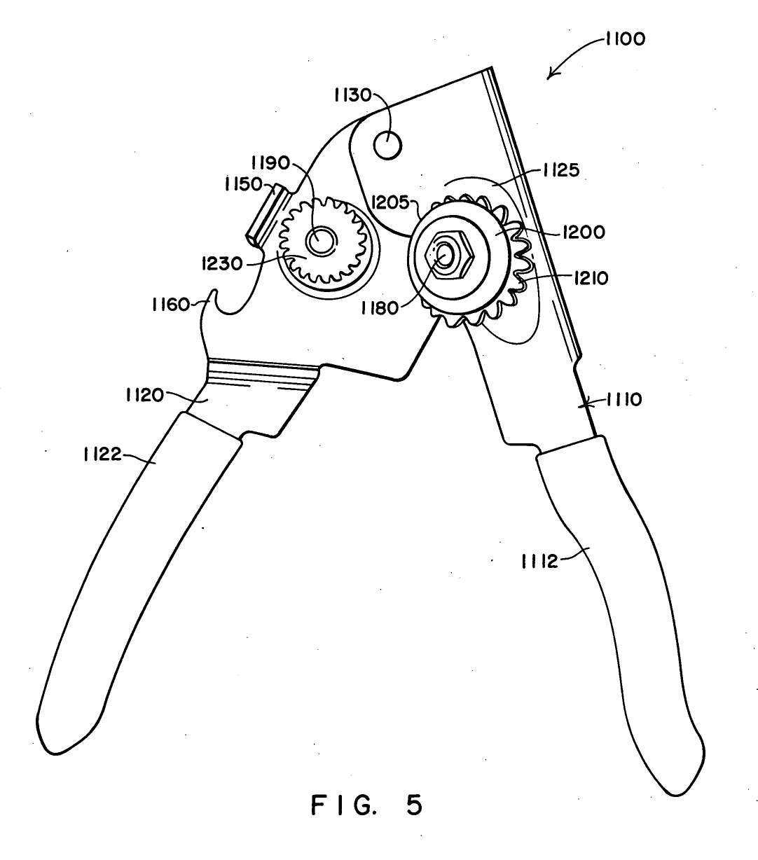

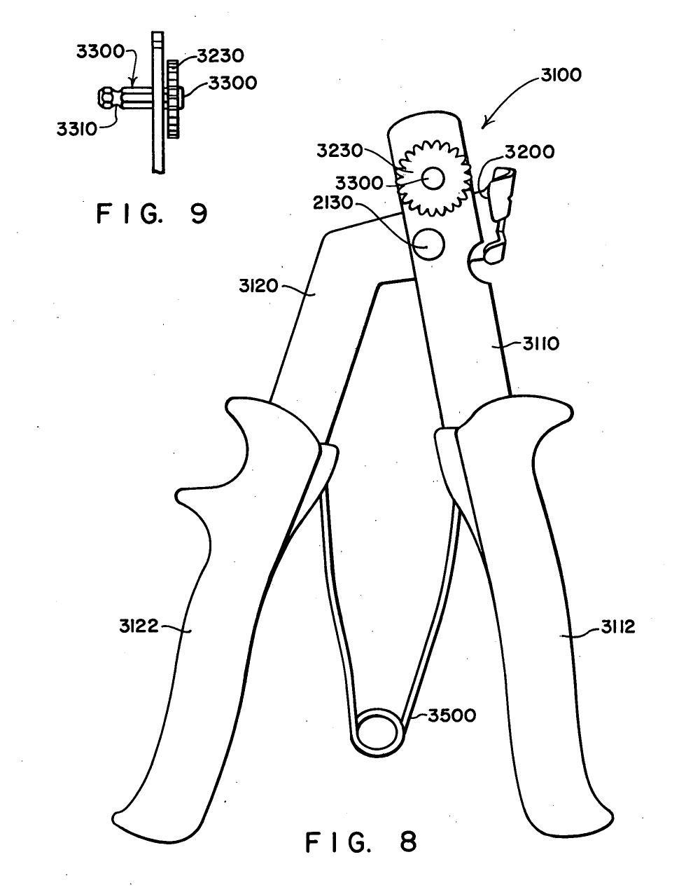

FIG. 8 shows still a further improved embodiment of a heavier and more efficiently operating can opener which is designated generally by the numeral 3100. The can opener 3100 has two arms 3110, 3120 pivotally connected at 3130. The arm 3110 carries a rotatable drive shaft 3300 that extends therethrough. A toothed drive wheel 3230 is securely connected to the drive shaft 3300 at a location on one side of the arm 3110 (as is shown in FIG. 9). A male drive formation—typically a hex shaft having a circumferentially extending groove 3310 (in the manner of the drive shaft 1300 shown in FIG. 6) is provided at a location on the other side of the handle 3310. When the arms 3110, 3120 are squeezed toward each other or are closed, a cutter formation (namely the metal edge 3200) moves toward and then alongside the toothed drive wheel 3230 just as the edge 205 of the cutting wheel 200 FIGS. 1-3 and the edge 1205 of the cutting wheel 1200 shown in FIGS. 4-5 move toward and then alongside the toothed drive wheels 230, 1230, respectively when the handles 110, 120 and 1110, 1120 are moved toward each other, respectively.

Although the can opener 3100 of FIG. 8 might appear to be of a lesser industrial construction and might appear to be less able to de-lid gallon paint cans and the like than are the can opener 2100 of FIG. 7, tests have shown that the simpler and less costly to construct can opener 3100 of FIG. 8 actually will de-lid gallon paint cans and the like somewhat more easily and somewhat more efficiently than will the improved can opener 2100 shown in FIG. 7.

What has proved to be a significant advantage possessed by the somewhat simpler can opener 3100 of FIG. 8 (in comparison with the already improved can opener 2100 of FIG. 7) is that the embodiment of FIG. 8 has no gears to drivingly connect for concurrent rotation such gear-carrying shafts 2180, 2190 as are utilized by the embodiment 2100 of FIG. 7. None of the torque applied to turn the toothed drive wheel 3230 in the embodiment 3100 of FIG. 8 is diverted through gears to drive or turn a cutting wheel or cutter formation. All the torque that is applied through a male drive formation 3300 (shown in FIG. 9) to turn the toothed drive wheel 3230 is, in fact, used to turn the toothed drive wheel 3230—which preferably has hardened teeth that bite into the underside of the rim of gallon paint cans and the like that are gripped by the opener 3100.

The improvements noted just above, taken in combination with the ergonomically configured hand grips 3112, 3122, have given the simple yet heavily constructed can opener embodiment 3100 of FIG. 8 a much improved capability to sequentially open a series of gallon paint cans for use by painters—and other similar heavy duty cans that, when smoothly de-lidded, are suitable for many other uses by mechanics and others.

Because the elongate arms 110, 120, 1110, 1120, 2110, 2120, 3110 and 3120 are sometimes referred to by those skilled in the art as “handles” rather than as “arms,” the terms “handles” and “arms” are used somewhat interchangeably in the foregoing description, and in the claims that follow. Likewise the cutting wheels 200, 1200, 2200 and the cutting edge 3200 are somewhat interchangeably referred to as “cutting formations” and as “puncture formations”—and the drive wheels 230, 1230, 2230, 3230 are somewhat interchangeably referred to as “drive formations.”

Although the invention has been described in its preferred form with a certain degree of particularity, it is understood that the present disclosure of the preferred form has been made only by way of example, and that numerous changes in the details of construction and the combination and arrangement of parts and the manner of operation may be resorted to without departing from the spirit and scope of the invention.

What is claimed is:

1. A hand held can opener designed to be compressively gripped in one hand to cause the can opener, in turn, to grip a metal can and to circumferentially sever a lid from the gripped can while a portable power tool that is drivingly connected to the can opener is held in an opposite hand to operate the can opener, with the can opener comprising:
a) first and second elongate handle formations having portions that overlie each other and are pivotally connected for angular movement about a first transversely extending axis between a closed position wherein lengthy portions of the handle formations are relatively narrowly spaced and cooperate to assume substantially a relatively narrow V-shaped formation, and an opened position wherein the lengthy portions are more widely spaced and cooperate to assume a relatively wider V-shaped formation;
b) a drive shaft extending through a hole defined by the first elongate handle formation at a location relatively near to the location of the pivotal connection of the first and second handle formations, with the drive shaft being rotatable relative to the first elongate handle formation about a second transversely extending axis that substantially parallels the first transversely extending axis, and having opposed end regions located on opposite sides of the first elongate handle formation;
c) a toothed drive wheel mounted on the drive shaft near one of the opposed end regions, and configured to be pressed against to drivingly engage a circumferentially extending rim of a can having a lid that is to be severed from the can;
d) a drive formation defined by the other of the opposed end regions of the drive shaft, and being rotatable by a portable power tool connected thereto to cause the toothed drive wheel to turn; and,
e) a cutting formation carried by the second elongate handle formation at a location where the cutting formation is movable toward and away from the toothed drive wheel when the second elongate handle formation is pivoted toward and away from the first elongate handle formation, respectively, and being configured to puncture a peripheral region of a can lid when a can is grasped between the toothed wheel and the puncture formation when the first and second handle formations are pivoted to the closed position, and to cut around a circumference of the lid when the drive formation is turned by a portable power tool to thereby sever the lid from the can.

2. The can opener of claim 1 additionally including an ergonomic grip formation defined by at least one of the opposite end regions of the first and second elongate handle formations.

3. The can opener of claim 1 additionally including ergonomic grip formations defined by each of the opposite end regions of the first and second elongate handle formations.

4. The can opener of claim 1 additionally including a spring interposed between the first and second elongate handle formations biasing the opposite end regions of the first and second handle formations away from each other.

5. The can opener of claim 1 wherein the cutting formation is a cutter wheel carried by and rotatable relative to the second elongate handle formation about a third axis inclined relative to the first and second axes, and having a cutting surface that is movable alongside the toothed drive wheel to effect the severance of the lid.

6. The can opener of claim 5 additionally including first and second toothed gears that drivingly engage when the first and second elongate handle formations are pivoted toward each other, and that cause the cutter wheel to turn when the toothed drive wheel is turned by a power tool, so the cutter wheel cooperates with the toothed drive wheel to move a can relative to the can opener.

7. The can opener of claim 1 wherein the cutting formation is a pointed cutting metal surface that pivots in a plane extending along one side of the toothed drive wheel.

8. A can opener designed to be held in one hand to grip a metal can and to circumferentially cut a lid from the gripped can while a portable power tool that is drivingly connected to the can opener is held in an opposite hand to operate the can opener.

9. The can opener of claim 8, comprising:
a) first and second elongate handles having handle portions that overlie each other and are pivotally connected for angular relative movement toward and away from each other about a first transversely extending axis between a closed position wherein opposite end regions of the first and second handles are relatively closely angularly spaced from each other forming a more closed generally V-shaped configuration than when said opposite end regions are in an opened position wherein the opposite end regions are relatively more widely angularly spaced from each other forming a more open generally V-shaped configuration;
b) a drive shaft extending through a hole defined by the first elongate handle at a location relatively near to the location of pivotal connection of the first and second handles, with the drive shaft being rotatable relative to the first elongate handle about a second transversely extending axis extending substantially parallel to the first transversely extending axis;
c) a toothed wheel mounted on the drive shaft at a location near one end region thereof on one side of the first elongate handle for rotation with the drive shaft;
d) a drive formation defined by an opposite end region of the drive shaft on an opposite side of the first elongate handle; and,
e) a puncture formation carried by the second elongate handle at a location where the puncture formation is movable toward and away from the toothed wheel when the second elongate handle is pivoted toward and away from the first elongate handle, respectively, and being configured to puncture a peripheral region of a can lid when a can is grasped between the toothed wheel and the puncture formation when the first and second handles are pivoted to the closed position, and to cut around a circumference of the lid when the drive formation is turned by a portable power tool to thereby sever the lid from the can.

10. The can opener of claim 9 additionally including an ergonomic grip formation defined by at least one of the opposite end regions of the first and second elongate handles.

11. The can opener of claim 9 additionally including ergonomic grip formations defined by each of the opposite end regions of the first and second elongate handles.

12. The can opener of claim 9 additionally including a spring interposed between the opposite end regions of the first and second elongate handles biasing the opposite end regions of the first and second handles away from each other.

13. The can opener of claim 9 wherein the puncture formation is a cutter wheel carried by and rotatable relative to the second elongate handle about a third axis inclined relative to the first and second axes, and having a cutting surface that is movable alongside the toothed drive wheel.

14. The can opener of claim 13 additionally including first and second toothed gears that drivingly engage when the first and second elongate handles are pivoted toward each other, and that cause the cutter wheel to turn when the toothed wheel is turned by a power tool, so the cutter wheel cooperates with the toothed wheel to move a can relative to the can opener.

15. The can opener of claim 9 wherein the puncture formation is a pointed cutting formation that pivots in a plane that extends along one side of the toothed drive wheel.

16. A can opener having a drive connector to which a power tool can be connected to operate the can opener by turning the drive connector, comprising a pair of pivotally connected relatively elongate arms that are graspable near end regions of the arms spaced from where the arms are pivotally connected, with one of the arms carrying a cutting formation that can puncture a lid of a can and can be drawn circumferentially around the lid of the can to sever the lid from a sidewall of the can when the drive connector is turned while a perimeter of the can is being gripped and turned relative to the can opener by a toothed drive wheel drivingly coupled to the drive connector.

17. The can opener of claim 15 wherein the cutting formation is formed as an integral part of said one of the arms.

18. The can opener of claim 17 wherein the cutting formation is a sharpened surface of said one of the arms.

19. The can opener of claim 17 additionally including ergonomically configured hand grips on distal end regions of the elongate arms.

20. The can opener of claim 19 additionally including a spring biasing the elongate arms away from each other.
